(19) United States
(12) Patent Application Publication
(10) Pub. No.: US 2017/0074272 A1
(43) Pub. Date: Mar. 16, 2017

(54) MOTOR STRUCTURE OF UNMANNED AERIAL VEHICLE

(71) Applicant: SUNONWEALTH ELECTRIC MACHINE INDUSTRY CO., LTD., KAOHSIUNG CITY (TW)

(72) Inventors: ALEX HORNG, KAOHSIUNG (TW); TSO-KUO YIN, KAOHSIUNG (TW); CHI-MIN WANG, KAOHSIUNG (TW)

(21) Appl. No.: 15/218,981

(22) Filed: Jul. 25, 2016

(30) Foreign Application Priority Data
Sep. 11, 2015 (TW) 104130162

(51) Int. Cl. F04D 25/06; F04D 29/58; F04D 17/08; F04D 29/28; B64C 11/00; B64C 39/02

(52) U.S. Cl. CPC F04D 25/064; B64C 11/00; B64C 39/024; F04D 17/08; F04D 29/281; F04D 29/5806; B64C 2201/108; B64C 2201/042; F05B 2240/30; F05B 2260/221

(57) ABSTRACT

A motor structure of an unmanned aerial vehicle includes a shaft seat, a stator and an external rotor. The stator is mounted around the shaft seat. The stator has a plurality of winding slots. The external rotor includes a shaft, a hollow body and a guiding cover. The shaft is pivotally disposed on the shaft seat. The guiding cover is disposed on one end of the hollow body, and the guiding cover has a central supporting seat, a plurality of blades and a plurality of air flow openings. The blades are connected to the central supporting seat. Each of the air flow openings is located between two adjacent blades. A number of the blades is greater than or equal to a number of the winding slots.

### FIELD

The disclosure relates to a motor structure, more particular to a motor structure of an unmanned aerial vehicle.

### BACKGROUND

FIG. 1 illustrates an exploded perspective view of a power machine of a conventional unmanned aerial vehicle. After a motor structure of a conventional unmanned aerial vehicle is connected to a propeller, a power machine of the unmanned aerial vehicle can be formed, wherein the power machine can provide power required for takeoff and landing of the unmanned aerial vehicle. However, as shown in the “structure of flight vehicle” disclosed in TW Patent No. M499246 and FIG. 1, a plurality of large-size openings 52H is designed on an external rotor upper cover 52 of a conventional motor structure 50, and these large-size openings 52H expose a large part of a stator 54 inside the motor.

When a propeller 60 rotates, an air flow S generated by the propeller 60 usually carries a lot of dust W. Therefore, when the air flow S enters the motor through the large-size openings 52H, the dust W also enters the motor easily along with the air flow S, thereby severely polluting the stator 54. The large-size openings 52H not only let the dust W enter the motor easily, but also reduce a flow rate of the air flow S that enters the motor (with a given pressure, when the size of the opening increases, the resistance decreases, and the flow rate decreases). Because the flow rate of the air flow S is a key factor that affects heat dissipation inside the motor, once the flow rate of the air flow S decreases, a heat dissipation rate inside the motor also decreases, and therefore, the motor is easily overheated.

Therefore, it is necessary to provide a motor structure of an unmanned aerial vehicle, to solve the foregoing problem.

### SUMMARY OF THE INVENTION

In accordance with one aspect of the present disclosure, a motor structure of an unmanned aerial vehicle includes a shaft seat, a stator and an external rotor. The stator is mounted around the shaft seat. The stator has a plurality of winding slots. The external rotor includes a shaft, a hollow body and a guiding cover. The shaft is pivotally disposed on the shaft seat. The hollow body is used to accommodate the stator, and a plurality of permanent magnets are disposed inside the hollow body. The guiding cover is disposed on one end of the hollow body, and the guiding cover has a central supporting seat, a plurality of blades and a plurality of air flow openings. The blades are connected to the central supporting seat. Each of the air flow openings is located between two adjacent blades. A number of the blades is greater than or equal to a number of the winding slots.

The blades of the guiding cover in the present disclosure can generate a powerful centrifugal force when the external rotor rotates, and with the blades and the centrifugal force generated by the blades, the dust that would otherwise enter the air flow openings along with the air flow can be pushed aside and thrown away, so as to prevent the dust from entering the hollow body while rotating and prevent the stator from being polluted by the dust. In addition, by controlling a number of the blades to be greater than or equal to a number of the winding slots, a size of the air flow openings can also be adjusted to a preferable value, and in this way, the flow rate of the air flow entering the hollow body can be improved, thereby improving the heat dissipation rate of the motor.

### BRIEF DESCRIPTION OF THE DRAWINGS

Aspects of the present disclosure are understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates an exploded perspective view of a power machine of a conventional unmanned aerial vehicle.

FIG. 2 illustrates an exploded perspective view of a motor structure of an unmanned aerial vehicle in accordance with some embodiments of the present disclosure.

FIG. 3 illustrates a perspective view of a motor structure of an unmanned aerial vehicle in accordance with some embodiments of the present disclosure.

FIG. 4 illustrates a perspective view of an external rotor in accordance with some embodiments of the present disclosure.

FIG. 5 illustrates a schematic view of a circular area of a guiding cover and a circular area of a central supporting seat in accordance with some embodiments of the present disclosure.

FIG. 6 illustrates a top view of a motor structure of an unmanned aerial vehicle in accordance with some embodiments of the present disclosure.

FIG. 7 illustrates a top view of a motor structure of an unmanned aerial vehicle in accordance with some embodiments of the present disclosure.

FIG. 8 illustrates a perspective view of a power machine of an unmanned aerial vehicle in accordance with some embodiments of the present disclosure.

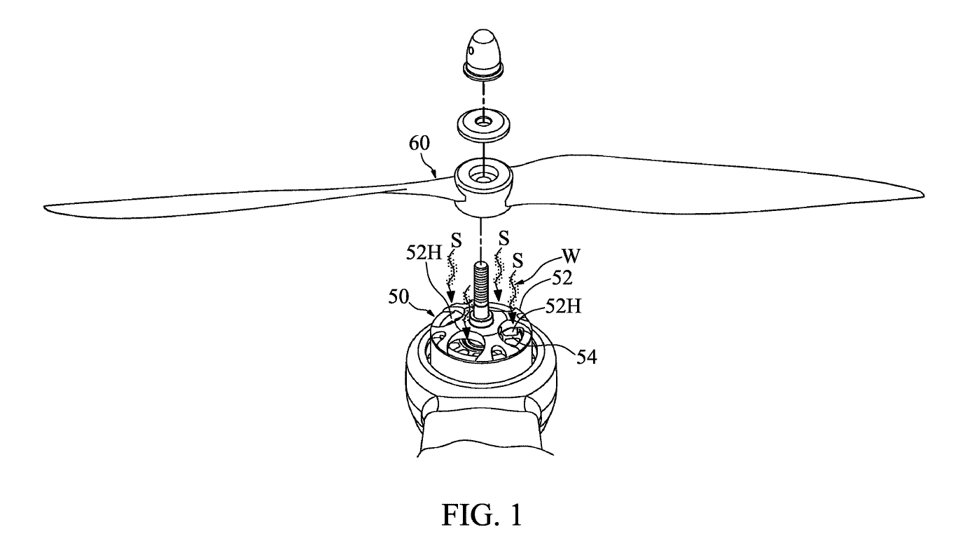

### DETAILED DESCRIPTION OF THE INVENTION

It is to be understood that the following disclosure provides many different embodiments or examples, for implementing different features of various embodiments. Specific examples of components and arrangements are described below to simplify the present disclosure. The present disclosure may, however, be embodied in many different forms and should not be construed as being limited to the embodiments set forth herein; rather, these embodiments are provided so that this description will be thorough and complete, and will fully convey the present disclosure to those of ordinary skill in the art. It will be apparent, however, that one or more embodiments may be practiced without these specific details.

In addition, the present disclosure may repeat reference numerals and/or letters in the various examples. This repetition is for the purpose of simplicity and clarity and does not in itself dictate a relationship between the various embodiments and/or configurations discussed.

It will be understood that when an element is referred to as being “on” another element, it can be directly on the other element or intervening elements may be present. In contrast, when an element is referred to as being “directly on” another element, there are no intervening elements present.

It will be understood that singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

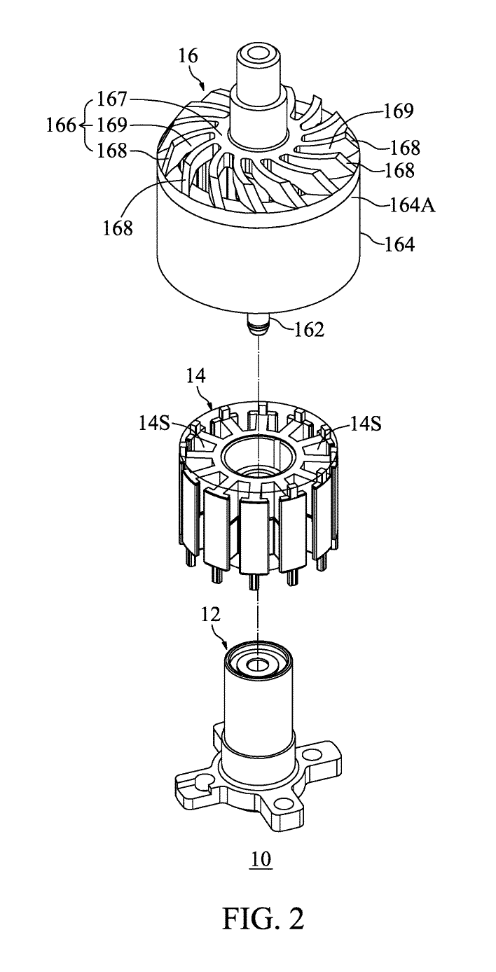

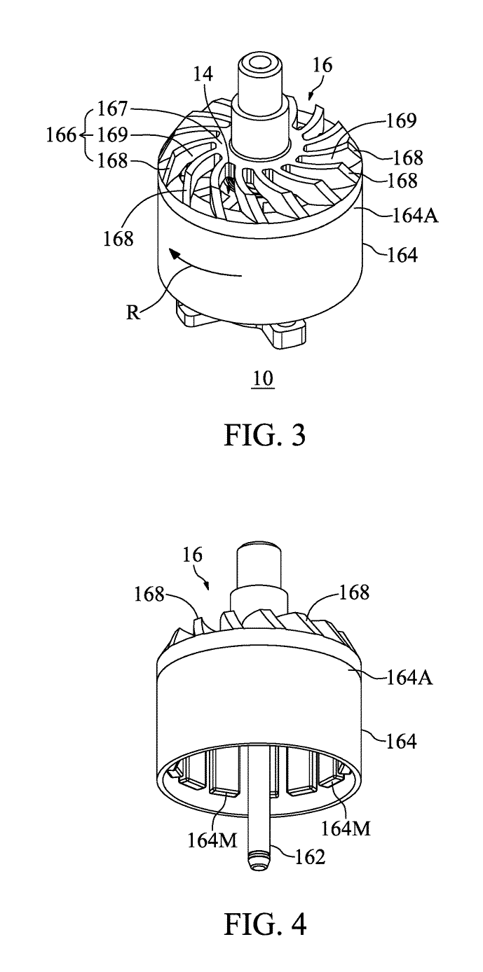

FIG. 2 illustrates an exploded perspective view of a motor structure of an unmanned aerial vehicle in accordance with some embodiments of the present disclosure. FIG. 3 illustrates a perspective view of a motor structure of an unmanned aerial vehicle in accordance with some embodiments of the present disclosure. With reference to FIG. 2 and FIG. 3, a motor structure 10 of an unmanned aerial vehicle in accordance with some embodiments of the present disclosure includes a shaft seat 12, a stator 14, and an external rotor 16. In some embodiments, the unmanned aerial vehicle can be an aerial shooting vehicle (such as an aerial shooting helicopter) or a pilotless aircraft.

The stator 14 is mounted around the shaft seat 12, and the stator 14 has a plurality of winding slots 14S, for wiring of coils (not shown in the figure).

FIG. 4 illustrates a perspective view of an external rotor in accordance with some embodiments of the present disclosure. With reference to FIG. 2, FIG. 3, and FIG. 4, the external rotor 16 includes a shaft 162, a hollow body 164, and a guiding cover 166. The shaft 162 is pivotally disposed on the shaft seat 12. The hollow body 164 is used to accommodate the stator 14, and a plurality of permanent magnets 164M are disposed inside the hollow body 164.

The guiding cover 166 is disposed on one end 164A of the hollow body 164, and the guiding cover 166 has a central supporting seat 167, a plurality of blades 168, and a plurality of air flow openings 169.

The blades 168 are connected to the central supporting seat 167. Each of the air flow openings 169 is located between two adjacent blades 168. In some embodiments, a number of the blades 168 is equal to a number of the air flow openings 169, and preferably, the number of the blades 168 is greater than or equal to a number of the winding slots 14S, i.e. the number of the air flow openings 169 is greater than or equal to the number of the winding slots 14S, so that a size of the air flow openings 169 can be adjusted to a preferable value, thereby increasing a flow rate of an air flow that enters the hollow body 164, so as to improve a heat dissipation rate of the motor.

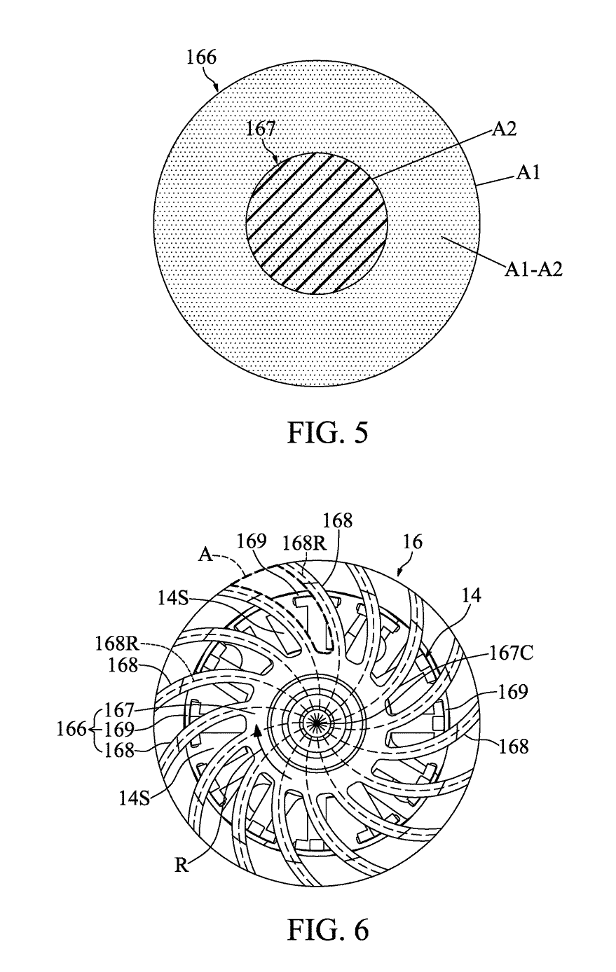

FIG. 5 illustrates a schematic view of a circular area of a guiding cover and a circular area of a central supporting seat in accordance with some embodiments of the present disclosure. FIG. 6 illustrates a top view of a motor structure of an unmanned aerial vehicle in accordance with some embodiments of the present disclosure. With reference to FIG. 2, FIG. 3, FIG. 5, and FIG. 6, to make the flow rate of the air flow that enters the hollow body 164 achieve efficacy of improving the heat dissipation rate of the motor, the number of the blades 168 should be greater than or equal to 9, and is preferably 11 to 19, and an opening area A of each of the air flow openings 169 satisfies the following relation:

(A1−A2)/19≦A≦(A1−A2)/9

where A1 is a circular area of the guiding cover 166, and A2 is a circular area of the central supporting seat 167.

In addition, in order to significantly improve the heat dissipation rate of the motor, in some embodiments, the opening area of each of the air flow openings 169 can be greater than a trough area of each of the winding slots 14S, so that the flow rate of the air flow, which has entered the hollow body 164 from each of the air flow openings 169, can be further increased after the air flow enters each of the winding slots 14S (because the trough area is smaller, the resistance increases, and therefore, the flow rate increases), so as to accelerate heat dissipation of the stator 14.

With reference to FIG. 3 and FIG. 6 again, to enable the blades 168 to generate a vortex air flow and a centrifugal force during rotation to push aside and throw away the dust that would otherwise enter the air flow openings 169 along with the air flow, in some embodiments, the blades 168 are arc-shaped blades, and the arc-shaped blades bend along a direction reverse to a rotation direction R of the external rotor 16. Alternatively, in some embodiments, the arc-shaped blades can bend along the rotation direction R of the external rotor 16.

In some embodiments, each of the arc-shaped blades defines an arc segment trajectory 168R, wherein each of the arc segment trajectories 168R overlaps each of the arc-shaped blades, and the arc segment trajectories 168R intersect at a center 167C of the central supporting seat 167. The foregoing design can prevent the dust from entering the hollow body 164 while rotating and prevent the stator 14 from being polluted by the dust. Alternatively, in some embodiments, the arc-shaped blades can also be connected to the central supporting seat 167 in a tangent manner, which can also achieve a dust-proof effect.

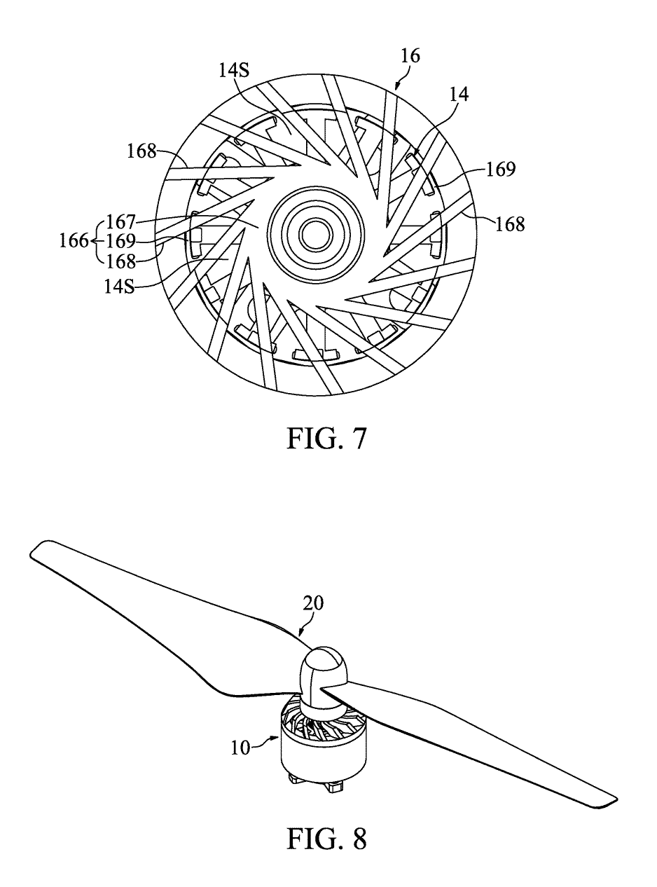

Refer to FIG. 7, which illustrates a top view of a motor structure of an unmanned aerial vehicle in accordance with some embodiments of the present disclosure. In some embodiments, the blades 168 can also be straight line shaped blades, and the straight line shaped blades are connected to the central supporting seat 167 in a tangent manner, which can also push aside and throw away the dust that would otherwise enter the air flow openings 169 along with the air flow. In addition, to maintain the stability of the external rotor 16 during rotation, preferably, each of the blades 168 has an uniform thickness along a length direction thereof.

FIG. 8 illustrates a perspective view of a power machine of an unmanned aerial vehicle in accordance with some embodiments of the present disclosure. With reference to FIG. 3 and FIG. 8, the motor structure 10 of the unmanned aerial vehicle can form a power machine of the unmanned aerial vehicle with a propeller 20, so as to provide power required for takeoff and landing of the unmanned aerial vehicle.

Moreover, the scope of the present application is not intended to be limited to the particular embodiments of the process, machine, manufacture, and composition of matter, means, methods and steps described in the specification. As those skilled in the art will readily appreciate form the present disclosure, processes, machines, manufacture, compositions of matter, means, methods, or steps, presently existing or later to be developed, that perform substantially the same function or achieve substantially the same result as the corresponding embodiments described herein may be utilized in accordance with some embodiments of the present disclosure.

Accordingly, the appended claims are intended to include within their scope such processes, machines, manufacture, and compositions of matter, means, methods or steps. In addition, each claim constitutes a separate embodiment, and the combination of various claims and embodiments are within the scope of the invention.

What is claimed is:

1. A motor structure of an unmanned aerial vehicle, comprising:
a shaft seat;
a stator mounted around the shaft seat, wherein the stator has a plurality of winding slots; and
an external rotor including a shaft, a hollow body and a guiding cover, wherein the shaft is pivotally disposed on the shaft seat, the hollow body is used to accommodate the stator, a plurality of permanent magnets are disposed inside the hollow body, the guiding cover is disposed on one end of the hollow body, the guiding cover has a central supporting seat, a plurality of blades and a plurality of air flow openings, the blades are connected to the central supporting seat, each of the air flow openings is located between two adjacent blades, and a number of the blades is greater than or equal to a number of the winding slots.

2. The motor structure of claim 1, wherein an opening area of each of the air flow openings is greater than a trough area of each of the winding slots.

3. The motor structure of claim 1, wherein the number of the blades is greater than or equal to 9.

4. The motor structure of claim 3, wherein the number of the blades is 11 to 19 inclusive.

5. The motor structure of claim 1, wherein an opening area A of each of the air flow openings satisfies the following relation:
(A1−A2)/19≦A≦(A1−A2)/9
where A1 is a circular area of the guiding cover, and A2 is a circular area of the central supporting seat.

6. The motor structure of claim 1, wherein a number of the air flow openings is greater than or equal to the number of the winding slots.

7. The motor structure of claim 1, wherein the blades are arc-shaped blades, each of the arc-shaped blades defines an arc segment trajectory, and each of the arc segment trajectories overlaps each of the arc-shaped blades.

8. The motor structure of claim 7, wherein the central supporting seat has a center, and the arc segment trajectories intersect at the center.

9. The motor structure of claim 1, wherein the blades are straight line shaped blades, and the straight line shaped blades are connected to the central supporting seat in a tangent manner.

10. The motor structure of claim 1, wherein each of the blades has an uniform thickness along a length direction thereof.
